(19) United States
(12) Patent Application Publication
(10) Pub. No.: US 2005/0232624 A1
(43) Pub. Date: Oct. 20, 2005

(54) Housing for surveillance camera with integrated uninterruptible power supply

(76) Inventor: Cyrus Baldwin, San Diego, CA (US)

Correspondence Address: STETINA BRUNDA GARRED & BRUCKER, 75 ENTERPRISE, SUITE 250, ALISO VIEJO, CA, 92656, US

(21) Appl. No.: 11/088,302

(22) Filed: Mar. 24, 2005

Related U.S. Application Data
(60) Provisional application No. 60/555,780, filed on Mar. 24, 2004.

(51) Int. Cl. G03B 7/26

(52) U.S. Cl. 396/278; 396/427

(57) ABSTRACT

A housing including an enclosure and a backup battery system is provided wherein the backup battery system may be disposed within the enclosure. The enclosure may also be locked such that unauthorized personnel may not tamper with the camera's operation. More particularly, the camera may be typically powered via a 110 VAC wall outlet. If the camera's normal power is interrupted, a battery of the backup battery system contained within the enclosure may route power to the camera such that the camera continues to capture images even though the power which normally operates the camera is interrupted.

### CROSS-REFERENCE TO RELATED APPLICATIONS

This application claims the benefits of U.S. Provisional Application No. 60/555,780 filed Mar. 24, 2004, the substance of which is incorporated herein by reference.

### STATEMENT RE: FEDERALLY SPONSORED RESEARCH/DEVELOPMENT

Not Applicable

### BACKGROUND OF THE INVENTION

The present invention relates generally to back up power for a surveillance camera.

Surveillance camera systems are widely used for safety, security and information gathering. For example, surveillance camera systems may be installed at casinos, parking structures and buildings to provide personal safety, security of the grounds and/or to gather information, particularly related to illegal activity. However, in each of these situations, the surveillance system's cameras are vulnerable to tampering due to the wired power connection. For example, robbers, thieves and vandals may intentionally interrupt power to the system's camera such that the system's camera is inoperative while the surveyed area is being robbed or vandalized. Alternatively, earthquakes, power shortages or other unforeseen events may interrupt power to the camera resulting in lost surveillance.

Further, even short periods of disruption in power may result in lengthy gaps in surveillance. Many cameras used in the field are digital and include on-board computerized, electronic servers. Even if power to the camera is immediately reestablished, the surveillance system may still be inoperable for a period of time because the camera must be reinitiated or rebooted.

Known surveillance systems have included external uninterruptible power supplies. However, unauthorized personnel or nepharious actors may simply terminate the camera's power connection between the external uninterruptible power supply to disrupt the power to the camera to disable the surveillance camera.

Accordingly, there is a need for an improved system of providing secure back up power to the camera.

### BRIEF SUMMARY OF THE INVENTION

The deficiencies in the known art identified above as well as other deficiencies are addressed by the present invention illustrated herein. By way of example and not limitation, in an aspect of the present invention, a camera may be disposed within an enclosure along with a backup battery system. The backup battery system may provide an alternate source of power to the camera (e.g., electronic component(s)) disposed within the housing in the event the camera's normal power source is interrupted. For example, the alternate source may power the camera only when the camera's normal source of power (e.g., wall outlet) is interrupted such as by unauthorized personnel or a natural cause (e.g., earthquake). Hence, the enclosure and the backup battery system provide a self sufficient and secure unit that powers the camera even when the camera's normal power supply is interrupted.

Furthermore, the enclosure may be tamper proof in that unauthorized personnel will find it difficult to penetrate the enclosure to tamper with the camera, backup battery system or other electronics within the enclosure. For example, the enclosure may be fabricated from a non-transparent upper dome and a semi-transparent or transparent lower dome which are attachable to each other and may be locked onto each other via a pad lock. Accordingly, unauthorized personnel may not tamper with the backup battery system, the camera or any electronic component within the enclosure. Further, because the battery backup is located within the enclosure, it may not be apparent to a vandal that the camera will still operate after the primary power link is terminated.

Additionally, a wireless data transmitter may also be contained within the enclosure such that the images captured by the camera may be transmitted to an on site location or an off site location. This enables images to be captured and transmitted to an on-site location or off site location even if there are no attached wires or the enclosure is removed from its mounted position. For example, if the enclosure with the camera, backup battery system and the wireless data transmitter enclosed therein was mounted to a wall, then even if the enclosure was removed from the wall, provided there is no damage to the camera, the camera would still be capable of transmitting images to the on site location or the off site location.

The housing may further contain additional electronic components such as an on/off indicator light, circuit relay, power loss circuit, alarm trigger circuit and rocker switch. These electronic components may be useful for providing status of the backup battery system and camera. In particular, the circuit relay may be connected to the output of the switching power supply. When such output is charged, the circuit relay may hold open a power loss circuit and an alarm trigger circuit. In this state, the on/off indicator light, power loss circuit and the alarm trigger indicates that the backup battery system is operating in a normal fashion and that the power normally supplied to the camera (by way of example and not limitation, electrical wall outlet) is operating in a normal fashion. In contrast, when such output is not charged, the circuit relay may close the power loss circuit and the alarm trigger circuit such that they are connected to the battery of the backup battery system. Accordingly, the power loss circuit may sound a buzzer and emit an indicator light. Also, the alarm trigger circuit may send a signal to the camera to send a message to security or maintenance personnel indicating that the supplied power is not being supplied to the backup battery system in a normal fashion.

### BRIEF DESCRIPTION OF THE DRAWINGS

Features of the present invention will become more apparent upon reference to the drawings wherein:

FIG. 1 is a cross sectional perspective view of a backup battery system disposed within a wall mountable camera housing;

FIG. 2 is an electrical circuit diagram illustrating the circuit of the backup battery system integrated into the camera circuit;

FIG. 3 is a perspective view of a camera including a backup battery system disposed within a horizontal surface mounted housing; and

FIG. 4 is a top view of the lower half of the housing components as shown in FIG. 3.

### DETAILED DESCRIPTION OF THE INVENTION

The detailed description as set forth below in connection with the appended drawings is intended as a description of the embodiments of the present invention, and does not represent the only embodiment(s) of the present invention. It is understood that various modifications to the invention may be comprised by different embodiments and are also encompassed within the spirit and scope of the present invention. Further, the drawings referred to herein are for the purposes of illustrating various embodiments of the present invention and not for the purpose of limiting the same.

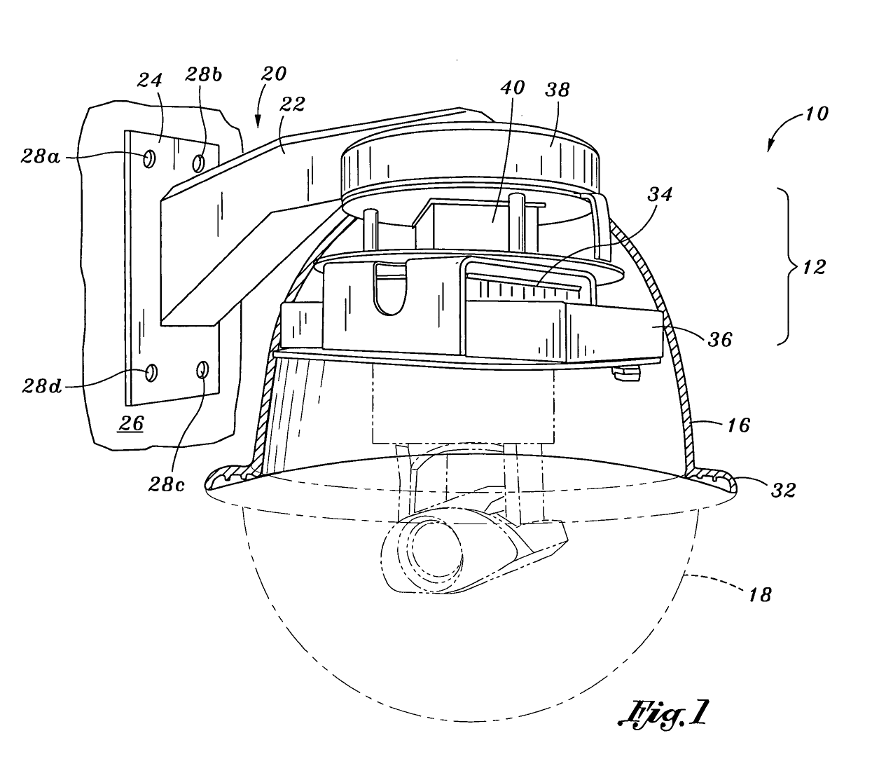

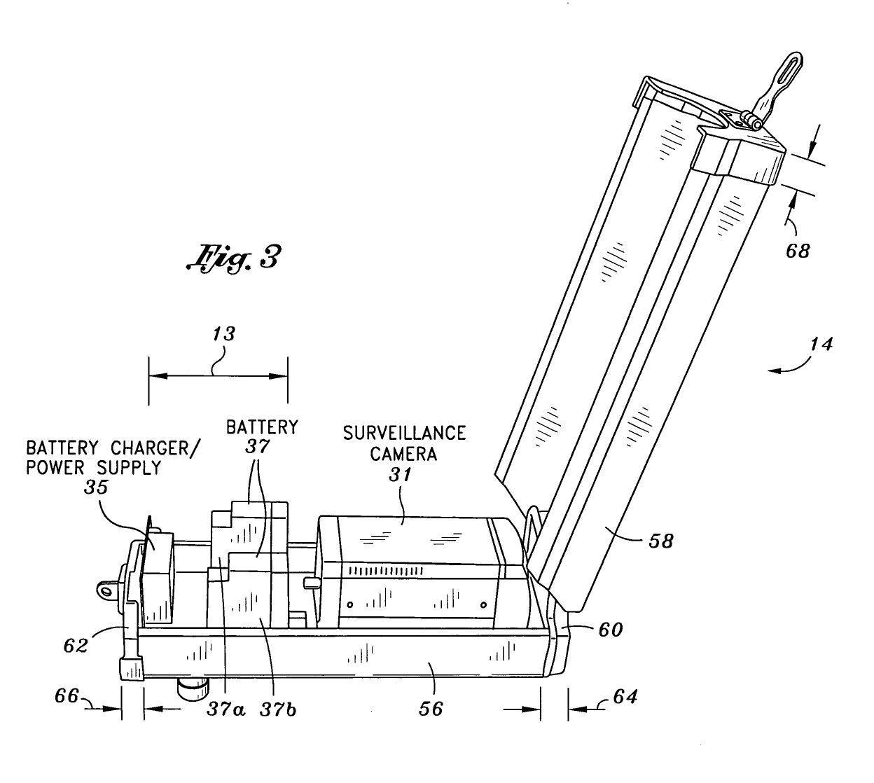

FIG. 1 illustrates a cross sectional view of a wall mountable camera housing 10 containing a backup battery system 12. It is also contemplated within the scope of the invention that the camera housing 10 and battery backup systems 12 of the present invention may be a horizontal surface mountable camera housing 14, as shown in FIG. 3, or in other configurations.

The housing 10 may comprise an upper enclosure or an upper dome 16 and a lower enclosure or a lower dome 18 (shown in phantom). The upper enclosure or the upper dome 16 may be attached to a wall mount 20. The wall mount 20 may include an arm 22 and a base plate 24. The base plate 24 may be connected to the wall 26, and the arm 22 may be connected to both the base plate 24 and the upper enclosure 16 such that the housing 10 is adjacently suspended to the wall 26. The base plate 24 may have four holes 28a, b, c, d which allow the housing 10 to be permanently attached to the wall 26 via a set of wall screws. The base plate 24 may also be attached to the arm 22. In particular, the base plate 24 and the arm 22 may be connected to each other via welding or the like. Likewise, the arm 22 may be connected to the upper enclosure 16 via welding or the like. Hence, the housing 10 may be suspended adjacent the wall 26.

The upper and lower enclosures 16, 18 when attached to each other may define an internal cavity which may contain both a camera 30 (in phantom) and the backup battery system 12 as well as other electronic components. The battery backup system 12 provides power to the camera 30 in the event that the power which is normally supplied to the camera 30 is interrupted. Accordingly, the camera 30 is still operational to survey an area even though the normal power to the camera 30 is interrupted.

Moreover, the upper enclosure 16 and the lower enclosure 18 may be locked to each other. The upper enclosure 16, once attached to the lower enclosure 18, may only be removed from the lower enclosure 18 via a key or other removal mechanism. As such, only maintenance personal or authorized personnel may access the camera 30 and the backup battery system 12 disposed within the upper and lower enclosures 16, 18.

Furthermore, the lower enclosure 18 may be sealed to the upper enclosure 16 forming a water-proof and element proof enclosure to avoid exposure of the components to the deleterious effects of the weather and environment. For example, the upper enclosure 18 may have a semi-spherical configuration with a shroud 32 (see FIG. 1) about its lower portion. The shroud 32 may have an opening larger than an opening of the lower enclosure 18 such that the shroud 32 overlaps the lower enclosure opening. In this way, rain water which may fall onto the upper enclosure 16 may cascade off of the housing 10 to prevent water from entering the housing 10. Furthermore, the interface between the upper enclosure 16 and the lower enclosure 18 may be fitted with a rubber seal gasket or chemical sealant to prevent water from seeping into the housing 10. This further adds to the operational stability of the camera 30 by preventing water and other environmental elements from entering the internal cavity possibly damaging the electronics of the camera 30 and the battery backup system 12.

The upper enclosure 16 may be fabricated from a non-transparent rigid material, whereas, the lower enclosure 18 may be fabricated from a semi-transparent rigid material such that the camera 30 is able to view the external environment through the housing 10 but people are not able to look into the housing. By this way, the camera direction cannot be observed by unauthorized personnel, thieves and the like to avoid detection.

As discussed above, the backup battery system 12 may be disposed within the housing 10 to prevent unauthorized personnel from tampering with these components. More particularly, the battery charger/power supply 34 and battery 36 may be disposed within the housing 10. (see FIG. 1). Additionally, the battery charger/power supply 34 and battery 36 may be attached to a rotating mount 38. The rotating mount 38 may be disposed within the housing 10 but it is also contemplated within the scope of the present invention that the rotating mount 38 may be disposed externally adjacent the housing 10. Despite whether the rotating mount 38 is disposed within the housing or externally adjacent the housing, the rotating mount 38 may rotate independent of the housing 10 such that rotation of the rotating mount 38 and camera 30 does not rotate the housing 10. This serves the purpose of hiding the camera direction as it is being rotated throughout its field of surveillance.

The backup battery system 12 may be disposed within the upper enclosure 16 of the housing 10. More particularly, the battery charger/power supply 34 and battery 36 may be disposed in the upper enclosure 16 of the housing 10. Also, the battery charger/power supply 34 may be disposed above the battery 36. (see FIG. 1). Further, a switching power supply 40 may be disposed within the upper enclosure 16 to drop the supplied power to the requirements of the battery charger/power supply 34. In particular, the switching power supply 40 may step the voltage down to 24 VDC. In FIG. 1, the supplied power (e.g., electrical wall outlet of 110 VAC) is in electrical communication with the battery charger/power supply 34 via a channel within the arm 22. Although the switching power supply 40 steps down the supplied power of 110 VAC to 24 VDC, it is also contemplated that the switching power supply 40 may transform the supplied power to other voltages, as needed by the backup battery system 12. Also, it is contemplated within the scope of the present invention that the supplied power may be 24 VAC, 100 to 260 VAC, or other voltages as needed. For example, the supplied power may be power supplied by an electrical wall outlet in an European country or other country. However, for the purpose of clarity, the various aspects of the present invention discussed herein shall be discussed in relation to a supplied power of 110 VAC.

The 24 VDC may additionally be stepped down to 12 VDC and delivered to the surveillance camera 30 via the battery charger/power supply 34. Simultaneously, the 12 VDC may also be delivered to the battery 36 for trickle charging the battery as long as the supplied power is not interrupted. When the supplied power is interrupted, the battery may supply 12 VDC to the battery charger/power supply 34 which routes this current to the camera 30 allowing the camera 30 to continue its operation. Hence, even though the supplied power may be interrupted or tampered with, the surveillance camera 30 remains operational. The battery backup system 12 maybe constructed as shown in FIG. 1, but is not limited to that construction. The battery back up system 12 may comprise any known functional uninterruptible power supply configuration. U.S. Pat. No. 5,982,652 generally describes known uninterruptible power supply configurations, the substance of which is incorporated herein by reference.

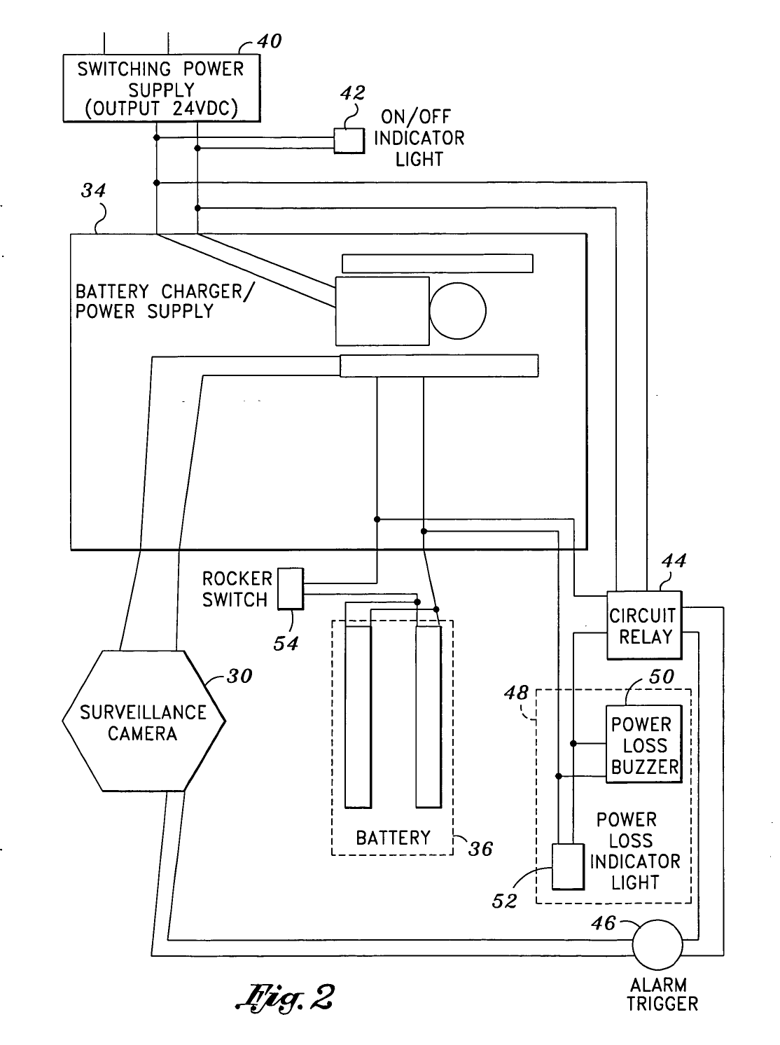

Referring to FIG. 2, the output of the switching power supply 40 (i.e., 24 VDC power) may also be connected to an on/off indicator light 42 and a circuit relay 44. In particular, the on/off indicator light 42 may contain an indicator light such as a light emitting diode which remains illuminated as long as power flows from the switching power supply 40 in a regular manner. The on/off indicator light 42 remains illuminated as long as power flowing from the switching power supply 40 approximates 24 VDC.

The circuit relay 44 may be an electromagnet which holds open an alarm trigger circuit 46 and a power loss circuit 48 as long as the supplied power flows from the switching power supply 40 in a regular manner. When the power from the switching power supply 40 flows in an irregular manner, the electromagnet of the circuit relay 44 may close the alarm trigger circuit 46 and the power loss circuit 48. This in turn closes the circuit between the battery 36 and the alarm trigger circuit 46 and the circuit between the battery 36 and the power loss circuit 48. When power is supplied to the power loss circuit 48, the power loss circuit 48 which comprises a power loss buzzer 50 and a power loss indicator light 52 are activated. The buzzer 50 produces a sound and the indicator light 52 illuminates a light such as a red light. The sound and the light indicate that the power from the switching power supply 40 may be irregular so as to notify maintenance personnel or security that the supplied power may be interrupted or abnormal. The alarm trigger circuit 46, when activated, may send current to an alarm input of the camera 30 causing the camera 30 to send a notification to the camera user (e.g., security or office management) to indicate that power from the switching power supply 40 or the supplied power may have been interrupted.

The circuit between the battery 36 and the camera 30 may be connected to a rocker switch 54. The rocker switch 54 may have an on position and an off position. In the on position, power from the battery 36 may be routed to the camera 30 through the battery charger/power supply 34. In contrast, in the off position, power flowing from the battery 36 to the camera 30 may be interrupted. The rocker switch 54 may be placed in the off position when the camera is moved from one site to another site. The rocker switch 54 disconnects the battery 36 from the camera 30 such that the camera is turned off while in transit and the alarm trigger circuit and the power loss circuit are not activated.

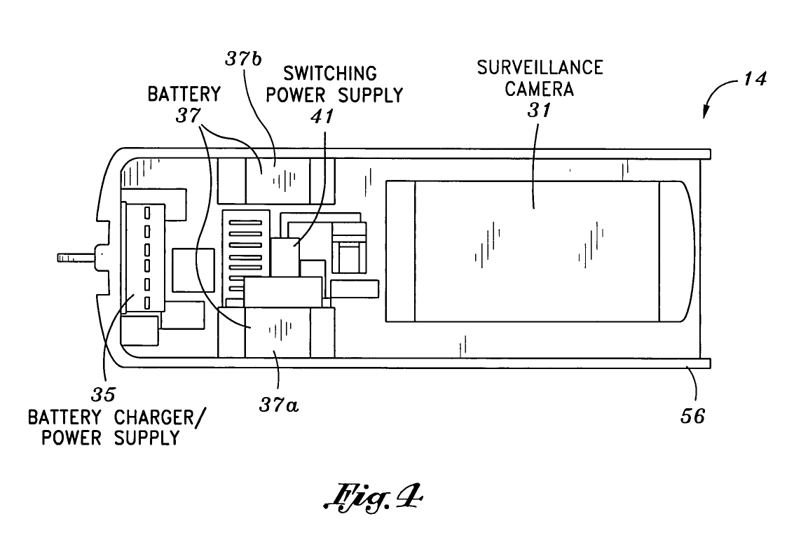

In another aspect of the present invention, a horizontal surface mounted housing 14 may be provided, as shown in FIGS. 3 and 4. The table top mounted housing 14 may be fabricated from two parts, namely, a base 56 and a cover 58. The base 56, as shown in FIG. 3 may have a rectangular box configuration with an open top. The base 56 may also be fabricated from a substantially tamper proof material (e.g., steel) such that unauthorized personnel may not break into the housing 14. The base 56 may further have a first end plate 60 and a second end plate 62 at a first end 64 and a second end 66 of the base 56, respectively. The first end plate 60 may be fabricated from a semi transparent or a transparent material such that the camera 31 within the housing 14 can capture images through the semi transparent or transparent material. The second end plate 62 may have a configuration which mates or matches a distal end 68 of the cover 58.

The first end plate 60 may have a square top configuration. The top of the first end plate 60 may define a pivot axis about which the cover 58 may pivotally rotate. The cover 58 may have a concave configuration such that the cover 58 and the base 56 jointly form an inner cavity sized and configured to receive the camera 31 and the backup battery system 13 when the cover 58 mates with base 56. When the cover 58 mates with the base 56, they may encapsulate the backup battery system 13 and the camera 31 to prevent unauthorized personnel from tampering with these components 13, 31 to disable them. In particular, the base 56 and cover 58 may form a tamper proof container such that objects cannot be inserted into the housing 14 by unauthorized personnel.

As shown in FIGS. 3 and 4, the housing 14 may encapsulate the battery charger/power supply 35, battery 37, and surveillance camera 31. In the embodiment shown in FIG. 3, two batteries 37a, 37b and the switching power supply 41 are contained within the housing 14. The second battery 37b provides extra power to the camera 31 such that the camera 31 is operable for a longer time after the supplied power to the camera 31 is interrupted.

A wireless data transmitter may also be connected to the cameras 30 or 31 and disposed within the housing. The wireless data transmitter may transmit images captured by the camera 30, 31 to an on site location or an off site location. For example, the wireless data transmitter may transmit the image data over a local area network to an on site location (e.g., security office) or over a wide area network to an off site location (e.g., police station). Also, the transmitted data may be received by a wireless data receiver and recorded on a storage medium. This wireless data transmitter may also be powered via the supplied power. However, it may be powered via the backup battery 36, 37a and 37b in case the supplied power is interrupted. As such, the images captured by the camera 30,31 may still be transmitted to an on site location or an off site location even though the housing 10, 14 is detached from the wall or desk. Also, the housing and camera system may have any on-board image capture and recording system.

A data recorder may also be connected to the cameras 30 or 31 and disposed within the housing 10, 14. The images captured by the camera 30 or 31 may be stored onto the data recorder then transmitted to the on site location or the off site location via the wireless data transmitter. Alternatively, the data recorder may record images captured by the camera 30 or 31 only when the supplied power to the camera 30 or 31 is interrupted. The backup battery 36, 37 may power the data recorder when the supplied power to the camera is interrupted. Accordingly, when the supplied power to the camera 30 or 31 is interrupted, the images captured by the camera 30 or 31 are recorded onto the data recorder located within the housing 10 or 14 until the supplied power is reestablished.

A data recorder may also be connected to the cameras 30 or 31 and disposed within the housing 10, 14. The images captured by the camera 30 or 31 may be stored onto the data recorder then transmitted to the on site location or the off site location via the wireless data transmitter. Alternatively, the data recorder may record images captured by the camera 30 or 31 only when the supplied power to the camera 30 or 31 is interrupted. The backup battery 36, 37 may power the data recorder when the supplied power to the camera is interrupted. Accordingly, when the supplied power to the camera 30 or 31 is interrupted, the images captured by the camera 30 or 31 are recorded onto the data recorder located within the housing 10 or 14 until the supplied power is reestablished.

This description of the various embodiments of the present invention is presented to illustrate the preferred embodiments of the present invention, and other inventive concepts may be otherwise variously embodied and employed. The appended claims are intended to be construed to include such variations except insofar as limited by the prior art.

1. A surveillance camera housing comprising:
a. an enclosure defining an inner cavity;
b. a camera disposed in said inner cavity powered by a power supply; and
c. a backup battery system disposed within the inner cavity, the system comprising:
i. a battery charger interconnected to the power supply;
ii. a chargeable battery interconnected to said battery charger; and
iii. a switching circuit for interconnecting the battery to the camera upon failure of the power supply.

2. The housing of claim 1 further comprising:
a. a circuit relay electrically communicable with the power supply, the circuit relay traverseable to an opened position when power from the power supply is delivered to the circuit relay and traverseable to a closed position upon failure of the power supply; and
b. a power loss indicator unit in electrical communication with the battery when the circuit relay is in the closed position and electrical communication with the battery is interrupted when the circuit relay is in the opened position.

3. The housing of claim 2 wherein the power loss indicator unit comprises a power loss buzzer and a power loss indicator light which is activated when the circuit relay is in the closed position.

4. The housing of claim 2 further comprising an alarm trigger in electrical communication with the battery when the circuit relay is in the closed position to send power from the battery to an alarm input of the camera causing the camera to send an alarm to security.

5. The housing of claim 1 further comprising an on/off indicator light connected to the battery charger for indicating whether the power supply is powering the camera.

6. The housing of claim 1 further comprising a rocker switch electrically interposed between the battery and the camera, the rocker switch having an opened position and a closed position, the battery being in electrical communication with the camera when the switch is in the closed position and electrical communication between the camera and the battery being interrupted when the switch is in the opened position.

7. The housing of claim 1 wherein the backup battery system is disposable above the camera.

8. The housing of claim 1 further comprising a rotatable mount disposed within the enclosure, attached to the backup battery system and attachable to the camera.

9. The housing of claim 1 wherein the enclosure includes a base and a cover.

10. The housing of claim 9 wherein the base and cover are lockable to each other.

11. The housing of claim 1 further comprising a wireless data transmitter disposed within the inner cavity for transmitting images captured by the camera to an on site location or an off site location.

12. The housing of claim 1 further comprising a rotatable mount attached to the camera and the enclosure for rotating the camera.

13. A method of assembling a surveillance camera, the method comprising the steps of:
a. providing an enclosure defining an inner cavity;
b. disposing a camera into the inner cavity;
c. disposing a backup battery system into the inner cavity; and
d. interconnecting a power supply to said camera and said battery backup system

14. The method of claim 13 further comprising the step of locking the enclosure.

15. The method of claim 13 further comprising the step of connecting the backup battery system to the camera.

16. The method of claim 16 comprising the step of powering the camera with a battery of the backup battery system when the supplied power is interrupted.
